(19) United States
(12) Patent Application Publication
(10) Pub. No.: US 2016/0328797 A1
(43) Pub. Date: Nov. 10, 2016

(54) GENERATION AND DISPLAY OF FIGURE CHARTS REPRESENTING TRADING ACTIVITY

(71) Applicant: TRADING TECHNOLOGIES INTERNATIONAL INC., CHICAGO, IL (US)

(72) Inventor: Christopher J. FIGY, Chicago, IL (US)

(21) Appl. No.: 14/707,871

(22) Filed: May 8, 2015

(51) Int. Cl. G06Q 40/04

(52) U.S. Cl. CPC G06Q 40/04

(57) ABSTRACT

Systems and methods to evaluate and generate figure charts are disclosed. An example method includes determining market information including buy and sell orders for a tradeable object. The example method includes generating a base representation for a price range associated with the market information and determining a volume of trade orders at each price in the price range. The example method includes separating the volume of trade orders at each price into a buy order volume and a sell order volume. The example method includes generating first volume representations for each buy order volume, generating second volume representations for each sell order volume, and rendering the volume representations with respect to the base representation, the first volume representations extending from the base representation in a first direction associated with buy orders and the second volume representations extending from the base representation in a second direction associated with sell orders.

### BACKGROUND

An electronic trading system generally includes a trading device in communication with an electronic exchange. The trading device receives information about a market, such as prices and quantities, from the electronic exchange. The electronic exchange receives messages, such as messages related to orders, from the trading device. The electronic exchange attempts to match quantity of an order with quantity of one or more contra-side orders.

Trading devices generally obtain market data pertaining to tradable objects. Such trading devices are also generally capable of rendering representations the market data.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a block diagram of an example trade order graphics engine for generating figure charts of different volumes of trading activity.

FIG. 5A illustrates an example graphical display including figure charts of different volumes of trading activity, which may be employed with certain disclosed embodiments.

FIG. 5B illustrates another example graphical display including figure charts of different volumes of trading activity, which may be employed with certain disclosed embodiments.

FIG. 5C illustrates another example graphical display including figure charts of different volumes of trading activity, which may be employed with certain disclosed embodiments.

FIG. 6 illustrates a flowchart of example instructions for generating figure charts of trading activity.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

This disclosure relates generally to electronic trading systems and, more specifically, to the generation and display of graphical representations of different volumes of trading activity associated with a tradeable object. As used herein, trading activity may encompass executed trades (a financial exchange between two parties and/or agents for an amount of a tradeable object) and/or trade orders (an offer to buy or sell an amount of a tradeable object, the offer made by a single party and/or agent).

Trading devices, establish a communication link (e.g., via a wired and/or wireless communication network) with an exchange via a gateway. In some examples, users associated with a trading device may request market information associated with a tradeable object. As used herein, market information includes data about a market for a tradeable object such as data on an inside market, a market depth, a last traded price (“LTP”), a last traded quantity (“LTQ”), or a combination thereof. Market information also may include existing and/or historical listings of orders for a tradeable object including requested transaction price, quantity, and a time of order such market information may be updated as it develops over a period of time.

Traders or other users of trading devices utilize candlestick charts to visualize the status and/or past status of a market. A candlestick chart includes a vertical line (also called a “wick”) with a rectangle (also called a “real body”) superimposed over the vertical line. A top and bottom of the wick represents a highest traded price and a lowest traded price for a tradeable object in a time interval, respectively. The top and bottom of the real body represent an opening and closing price of the tradeable object. The real body is generally colored according to the traversal of the opening and closing price. That is, first color of the real body will represent if the price closed higher than it opened (e.g., a bullish market) and a second color of the real body will represent if the price closed lower than it opened (e.g., a bearish market).

Using examples disclosed herein, figure charts showing volumes of trading activity associated with one or more tradeable objects may be generated. A trade order graphics engine, as disclosed herein, allows a trader to obtain market information for a tradeable object and generate a figure chart based on the market information. Generating figure charts related to trade volume allows a user of a trading device to better understand the market, identify arbitrage in a tradeable objects market and/or, more generally, determine the market value of a tradeable object beyond that of a candlestick chart. Generating figure charts also allows a trader to visually represent data such that the trader may more efficiently understand the status of a market for a tradeable object. The figure charts are compressed representations of the market information and/or status of the market. The trade order graphics engine disclosed herein transforms the market information from myriad numerical and textual data into a palatable and quickly comprehensible visual representation. Thus, while the market information and the figure chart both contain the same information, the figure chart allows a trader to understand the status of the market in a more efficient and timely manner.

For example, the user requests a graphical representation (e.g., a figure chart) of market information for a tradeable object. In particular, the request may indicate a desire to generate figure charts of different volumes of order activity for a tradeable object associated with an interval of time (e.g., an hour, a day, a week, etc.). In response to the request, the trading device acquires the requested market information associated with the interval of time. Using examples disclosed herein, the trading device determines a price range and a volume of order activity from the acquired market data. The trading device also determines for each price in the price range, which of the volume of order activity is associated with a buy order or a sell order. The determined volume of buy and sell orders for each price in the price range are graphically depicted by the trading device.

In some embodiments, value areas of the volume of the buy and sell orders are determined and depicted. As used herein, a value area is a price (or a range of prices) associated a percentage of order activity with respect to an entirety of order activity for a type of order. That is, a value area distinguishes where a large portion of the order activity has taken place. Smaller value areas represent a volume of trading concentrated around a price (or a small range of prices) for a time period. Generally, this represents stability in the market for this tradeable object for that time period. Larger value areas represent a volume of trading where activity did not concentrate around a price thus fluctuated for that time period. The value areas for buy and sell orders are graphically represented by the trading device adjacent, imposed, or in place of the graphical representations of the volume of buy and sell orders for each price in the price range.

In some examples, in response to a user request, generating graphical representations of different volumes of trading activity associated with a tradeable object may involve displaying different volumes of trading activity for multiple tradeable objects in a graphical display area. In other examples, in response to a user request, generating graphical representations of different volumes of trading activity associated with a tradeable object may involve displaying multiple graphical representations of time periods of trading activity for one tradeable object in a graphical display area. In yet other examples, in response to a user request, generating graphical representations of different volumes of trading activity associated with a tradeable object may involve displaying multiple graphical representations of time periods of trading activity for multiple tradeable objects in a graphical display area.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

Certain embodiments provide a method including determining, using a processor, market information for a tradeable object, the market information including buy orders and sell orders with respect to the tradeable object. The example method includes determining, from the market information using the processor, a price range associated with the market information. The example method includes generating a base representation for the price range associated with the market information. The example method includes determining, from the market information using the processor, a volume of trade orders at each price in the price range. The example method includes separating the volume of trade orders at each price in the price range into a buy order volume and a sell order volume based on the market information. The example method includes generating first volume representations for the buy order volume for each price in the price range. The example method includes generating second volume representations for the sell order volume for each price in the price range. The example method includes rendering, using the processor, the first volume representations and the second volume representations for each price in the price range with respect to the base representation, the first volume representations extending from the base representation in a first direction associated with the buy orders and the second volume representations extending from the base representation in a second direction associated with the sell orders.

Certain embodiments provide a system including a processor configured to determine market information for a tradeable object, the market information including buy orders and sell orders with respect to the tradeable object. The example processor is configured to determine, from the market information, a price range associated with the market information. The example processor is configured to generate a base representation for the price range associated with the market information. The example processor is configured to determine, from the market information, a volume of trade orders at each price in the price range. The example processor is configured to separate the volume of trade orders at each price in the price range into a buy order volume and a sell order volume based on the market information. The example processor is configured to generate first volume representations for the buy order volume for each price in the price range. The example processor is configured to generate second volume representations for the sell order volume for each price in the price range. The example processor is configured to render the first volume representations and the second volume representations for each price in the price range with respect to the base representation, the first volume representations extending from the base in a first direction associated with the buy orders and the second volume representations extending from the base in a second direction associated with the sell orders.

Certain embodiments provide a tangible computer-readable storage medium including instructions that, when executed, cause a processor to at least determine market information for a tradeable object, the market information including buy orders and sell orders with respect to the tradeable object. The example instructions cause the processor to at least determine, from the market information, a price range associated with the market information. The example instructions cause the processor to at least generate a base representation for the price range associated with the market information. The example instructions cause the processor to at least determine, from the market information, a volume of trade orders at each price in the price range. The example instructions cause the processor to at least separate the volume of trade orders at each price in the price range into a buy order volume and a sell order volume based on the market information. The example instructions cause the processor to at least generate first volume representations for the buy order volume for each price in the price range. The example instructions cause the processor to at least generate second volume representations for the sell order volume for each price in the price range. The example instructions cause the processor to at least render the first volume representations and the second volume representations for each price in the price range with respect to the base representation, the first volume representations extending from the base in a first direction associated with the buy orders and the second volume representations extending from the base in a second direction associated with the sell orders.

### II. Example Electronic Trading System

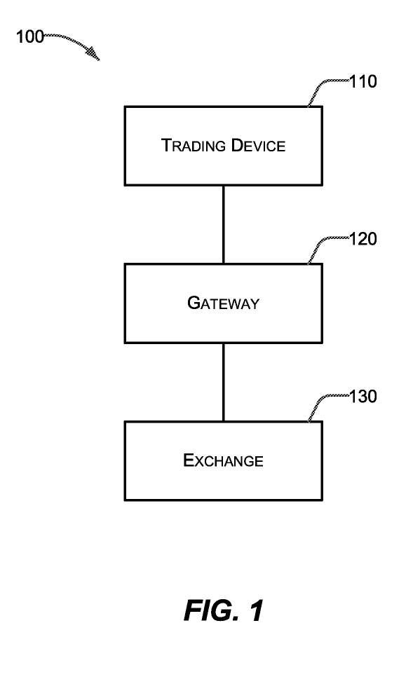

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

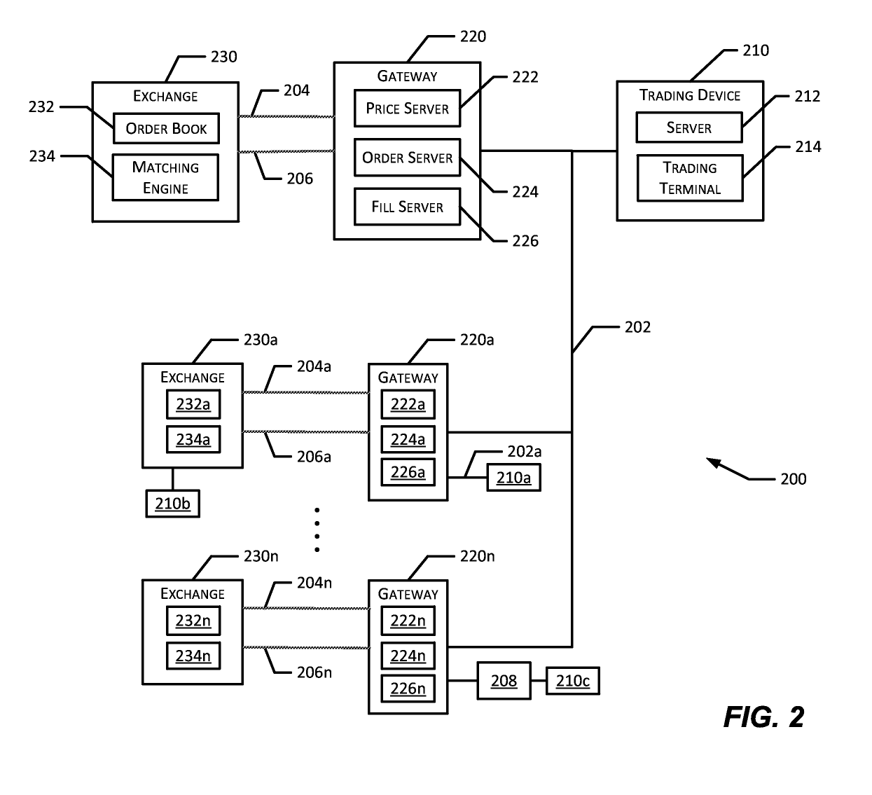

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

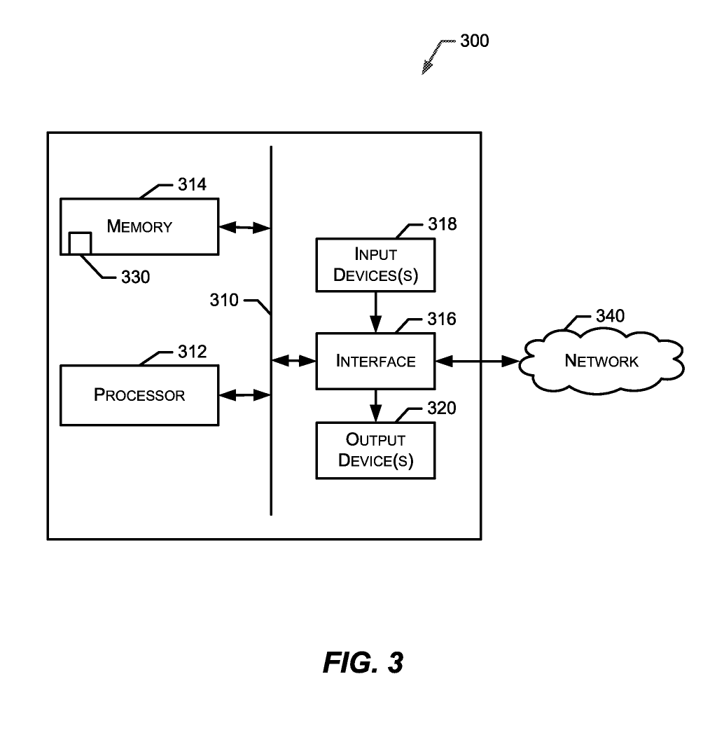

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Generation and Display of Figure Charts

Example method and apparatus to generate figure charts of different volumes of trading activity are disclosed herein.

As used herein, a buy order volume is a number of units for which bids exist, or did exist, on the market in a specified time interval. As used herein, sell order volume is a number of units for which “asks” exist, or did exist, on the market in the specified time interval.

As used herein, a starting price (also referred to herein as an opening price) is a first per unit price associated with a first order for a specified time interval. In some examples, there are buy order opening price and sell order opening price which each correspond to a first per unit price associated with a first sell order and the first per unit price associated with a first buy order.

As used herein, an ending price (also referred to herein as a closing price), is a final per unit price associated with a last order for a specified time interval. In some examples, there is a buy order closing price and a sell order closing price which each correspond to the last per unit price associated with the last sell order and the last per unit price associated with the last buy order in the specified time interval.

As used herein, a value area is a range of prices associated with a defined percentage (e.g., 70%) of trade order volume. In some examples, there may be a buy value area and a sell value area. For example, the buy value area designates the range of prices where 70% of the buy orders were placed for a specified time interval and the sell value area designates the range of prices where 70% of the sell orders were placed for the specified time interval.

In financial exchanges, trade orders are a request to conduct a financial transaction. Trade orders are generally include data identifying, for example, order type (e.g., buy or sell), price, quantity, and time. As disclosed herein, dividing and examining a plurality of trade orders for a tradeable object can provide insight into the market for such an object. That is, using example methods and apparatus disclosed herein, a trader has the ability to detect and capitalize on an arbitrage associated with a tradeable object.

For example, suppose a trader desires to know the past or current status of a market for a tradeable object in a specific interval of time. One way the trader could attempt to determine such a status is by analyzing a large amount numerical values from the market (e.g., a listing of trade order from the interval of time). However, this process is time consuming and, ultimately, inefficient. Another way the trader could attempt to determine the status is by using a candlestick chart. However, using a candlestick chart, the trader may not be able to tell how the behavior of the market. The candlestick only contains traditional OHLC (opening price, high price, low price, and close price) data in a visual form. Further, the candlestick information may only be in relation to actual executed trades (e.g. a completed buy and/or sell order). Using a manual analysis of raw data or viewing a candlestick chart, the trader may miss important details that are not easily identified or understood using such approaches.

If such a trader were able to utilize a trade order graphics engine to generate a figure chart, as disclosed herein, the trader can determine the status of a market for a tradeable object faster and in more detail. The trade order graphics engine obtain information regarding and depict executed trades and can also obtain and depict trade orders that have been placed (e.g., input but not yet accepted and/or executed). Combining completed and placed trade orders in a market analysis for a tradeable object allows a trader the ability to understand the way in which the market has behaved and/or is behaving beyond candlestick charts and pure numerical analysis. Further, visually representing the market for a tradeable object using a figure chart can allow the trader to discover details about the behavior of the market that may not otherwise be discoverable. For example, using a figure chart, a trader can determine where the value in a market lies. That is, the trader can more efficiently make better informed choices in line with a trading strategy.

The disclosed trade order graphics engine obtains market information regarding trade orders for a tradeable object to create a figure chart. As previously discussed, market information includes data about a market for a tradeable object such as data on an inside market, a market depth, a last traded price (“LTP”), a last traded quantity (“LTQ”), or a combination thereof. Market information also may include existing and/or historical listings of orders for a tradeable object including requested transaction price, quantity, and a time of order such market information may be updated as it develops over a period of time. The trade order graphics engine processes the market information related to one or more trade orders for the tradeable object. For example, the trade order graphics engine determines a type and a magnitude for each trade order detected in the market information. That is, the trade order graphics engine determines if a trade order is a buy order or a sell order for the tradeable object, and further determines how many units of the tradeable object are requested in each. The trade order graphics engine generates one or more figure charts to display the volume of different types of trade orders for each price associated with the trade orders from the market information. The figure charts generated by the trade order graphics engine provide a new window for traders to analyze the behavior and reaction of a market for a tradeable object by incorporating and depicting separated volumes of trade orders.

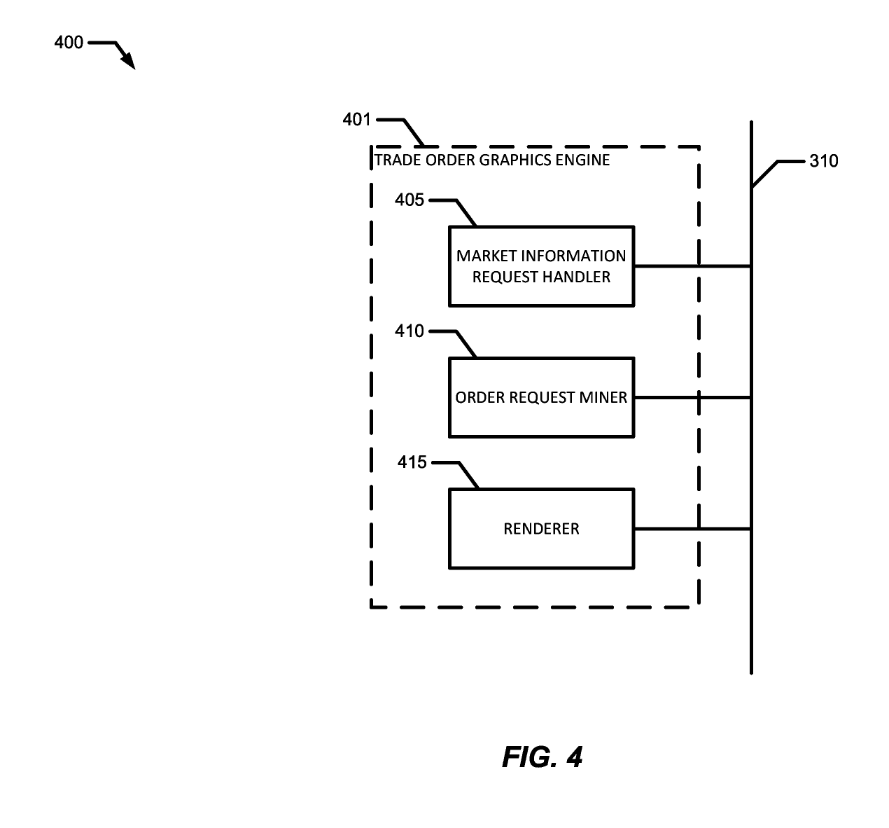

FIG. 4 is a block diagram of an example processing system 400 to implement a trade order graphics engine such as the example trade order graphics engine 401 of FIG. 4. The example processing system 400 includes the communication network 310 of FIG. 3 that is connected to a market information request handler 405, an order request miner 410, and a renderer 410. The processing system 400 can include the processor 312 of the example computing device 300 and/or other processor operating in or with respect to a trading device, for example.

The market information request handler 405 receives a request for a graphical representation of market information (e.g., volume of order activity) associated with a tradeable object. The market information request handler 405 transmits the request for market information to one of a gateway and/or an exchange (e.g., gateway 220 and/or exchange 230). The market information request handler 405 can identify one or more attributes associated with the respective request for market information, such as the associated tradeable object, an interval of time associated with the request, other market data, etc.

In some examples, the market information request handler 405 stores market information gathered in response to a request. For example, a user of a trading device may request market information regarding tradable object “XYZ,” for an interval between 9:00 AM and 10:00 AM on November 20th. The market information request handler 405 stores (e.g., caches, records, etc.) the market information for a period of time. By storing (e.g., temporarily or longer) the information, the market information request handler 405 keeps the market information easily available to the user to accommodate subsequent requests regarding such market information.

The market information request handler 405 additionally may detect if at least a portion of the requested market information is stored on the trading device. That is, a trading device may have market information regarding tradable object “XYZ,” for an interval between 9:00 AM and 10:00 AM on November 20^{th} stored thereon. If a subsequent request is made to the market information request handler 405 for “XYZ” market information from 9:30 AM to 10:30 AM, the market information request handler 405 can detect the market information from 9:00-9:30 AM stored on the trading device. In response to such a detection, the market information request handler 405 determines that only market information from 9:30-10:00 AM should be obtained.

In other examples, the market information request handler 405 may first attempt to obtain the requested market information from other trading devices. For example, a query may be sent across a local network (e.g., a Wi-Fi network) to determine if any devices on that same network have the market information associated with the request. If no other trading devices have such market information, the market information request handler 405 can then contact the gateway and/or exchange to request the desired market information. The obtained market information is transmitted to the order request miner 410 by the example market information request handler 405.

The example system 400 also includes an order request miner 410. The order request miner 410 analyzes the market information obtained by the market information request handler 405. The order request miner 410 analyzes the market information to determine information relevant to the graphical representation request of the user, the relevant information is parsed and made available to the renderer 415 for graphical representation. Such information to be graphed may include, a range of prices associated with orders for a time interval. For example, the range of prices associated with orders for the time interval may comprise all prices detected for a volume of order activity for each price in the price range, and a type of order for each of the volume of order activity. The order request miner 410 separates the volume of order activity at each price in the price range into buy order volume and sell order volume.

The order request miner 410 can determine from the market information what trading action (e.g., buying or selling) each order is associated with. For example, the type of the order may be (1) identified by data within metadata associated with the order, (2) denoted in a header of the order message, and/or (3) contained in the order message itself. Of course, the foregoing examples are non-exhaustive and any past or future data may be leveraged to identify the type of the order.

The order request miner 410 also determines the volume of the units designated in the trade order. For example, if the order request miner 410 analyzes a trade order to buy 1000 units of “COYG” at $95 per unit, then the order request miner 410 tags and/or stores a designation of 1000 units at the $95 dollar price point. That is, instead of one trade order at $95, the order request miner 410 stores and or tags 1000 units at $95. Such an action provides a status of the market such that single orders for large volume are afforded more affect to the graphical representation than those single orders with less than large volume. Thus, the order request miner 410 assures each order contributes to the graphical representation in such a way proportionate to its requested volume.

The order request miner 410 also determines for the time interval, an opening and/or first value associated with buy orders as well as a closing and/or last value associated with the buy orders. The order request miner 410 also determines for the time interval, an opening and/or first value associated with sell orders as well as a closing and/or last value associated with the sell orders.

In some examples, the order request miner 410 determines a value area for buy orders and/or sell orders. A value area refers to a price (or a range of prices) associated with a threshold amount (e.g., a large portion) of buy and/or sell orders. For example, if the value area is set to 70%, then the range of prices associated with 70% of the order volume for buy orders and 70% of the order volume for sell orders is determined by the order request miner 410. In some examples, the threshold amount may be determined by a user of a trading device, an administrator of trading devices, and/or a default value.

In some examples, the order request miner 410 packages or alters a format and/or file containing the data that is to be graphically represented by the example renderer 415. For example, if the market information is in a format not compatible with or unreadable by the renderer 415, the order request miner 410 may alter or reformat the data that is to be graphed such that the renderer 415 may read and utilize the data. For example, suppose the order request miner 410 receives the market information in a proprietary structured file (e.g., a proprietary eXtendible markup language (XML) file) that is unreadable by the renderer 415. The order request miner 410 detects that the information is unreadable by the renderer 415 and extracts the market information for constructing a figure chart. The order request miner 410 generates a file (e.g., alternate proprietary XML, non-proprietary XML, text (TXT), data (DAT), etc.) readable by the renderer 415 containing the extracted market information. The order request miner 410 transmits the readable file to the renderer 415.

The example system 400 also includes a renderer 415. The renderer 415 generates depictions of the data that is to be graphically represented (e.g., the determined market information, etc.). The renderer 415 generates a base or reference line (e.g., a vertical line, horizontal line, etc.) or other common point representative of the range of prices determined by the order request miner 410. The renderer 415 also generates representations of the volumes of buy and/or sell orders for each of the prices in the price range. Those volume representations extend from the base in respective directions depending upon whether the volume data relates to a buy order or a sell order, for example.

In some examples, the renderer 415 may color, shade, and/or gradient fill the volume representations. For example, the renderer 415 may color the volume representations the same, similar, and/or different color. The renderer 415 may shade the volume representations the same, similar, and/or different shade. The renderer 415 may also gradient fill the volume representations with the same, similar, and/or different gradient. In other examples, the renderer 415 may render the volume representations such that they extend in a same and/or similar direction while differentiating between buy and sell using at least one of color, shade, and/or gradient fill to represent a distinction between buy order volume and sell order volume.

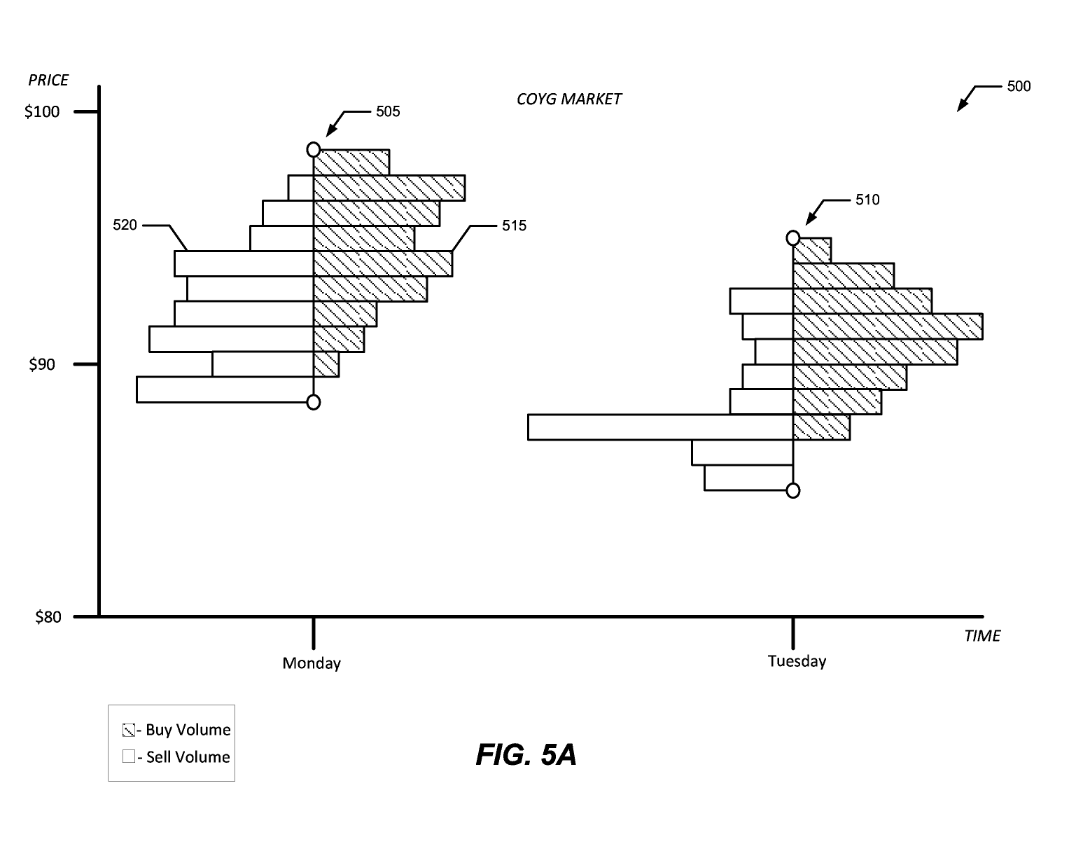

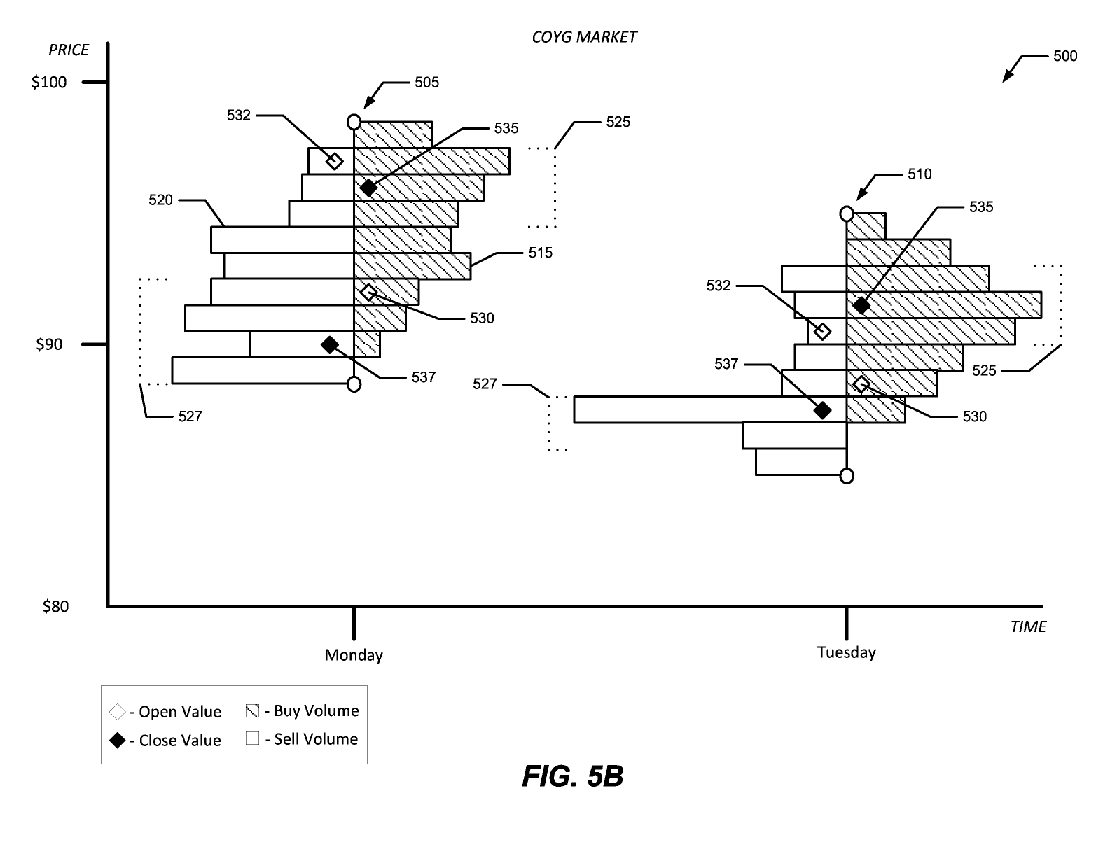

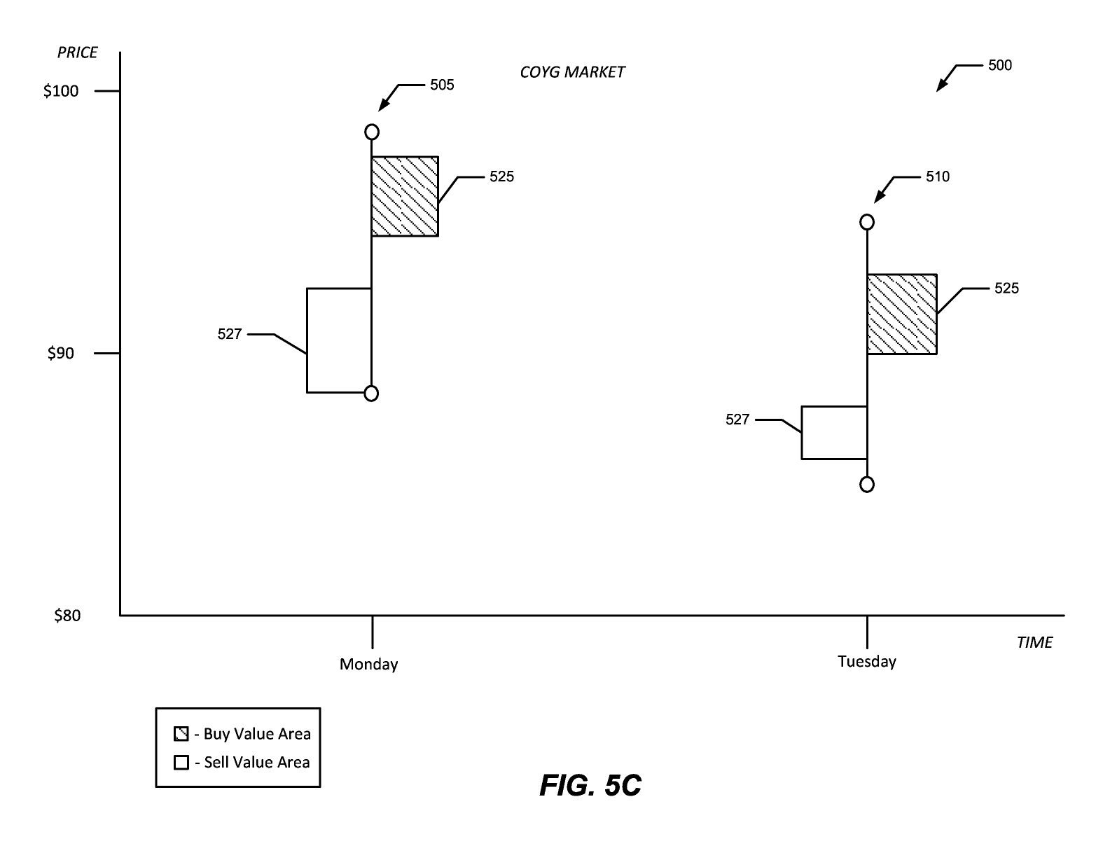

For example, for a particular price in the price range, a first rectangle with a length representative of the volume of buy orders at that price may be generated by the example renderer 415 as well as a second rectangle with a length representative of the volume of sell orders at that price may be generated by the example renderer 415. The renderer 415 renders the representations of the volumes of buy and/or sell orders with the bases of the representations of the volumes affixed to the vertical line such that they extend in a direction corresponding to their price type. These representations are depicted in FIGS. 5A-5C and discussed in more detail in conjunction with those figures.

The example renderer 415 also generates representations of the opening and closing prices for the time interval for each of the buy orders and the sell orders. Generally, the opening and closing price representations are rendered superimposed on the representations of the volumes of buy and/or sell orders by the renderer 415. However, the renderer 415 may be customized to utilize any icon and or method of graphically indicating such opening and closing prices for each of the buy and/or sell orders.

In some examples, the renderer 415 also generates value area representations for a time interval. Using the information associated with the value area determined by the order request miner 410, the renderer 415 may generate a representation of the value area. In some examples, the representations of the value areas are generated by changing the color of the representations of the volumes of buy and/or sell orders for prices in the value area. In other examples, the representations of the value areas are generated superimposed on the representations of the volumes of buy and/or sell orders for prices in the value area. In yet other examples, the renderer 415 generates a separate chart containing graphical representations of the value areas affixed to a representation of the price range for the specified time interval.

FIG. 5A illustrates an example graphical display 500 including figure charts 505, 510 visually representing different volumes of trading activity for a tradeable object generated according to example methods and systems disclosed herein. In the example FIG. 5A, a user has requested figure charts 505, 510 showing volumes of buy orders (e.g., buy order volume 515) and sell orders (e.g., sell order volume 520) for tradeable object “COYG” which were placed on Monday 505 and on Tuesday 510.

The market information request handler 405, in response to the request by the user, obtains market information from an exchange and/or gateway about the tradeable object “COYG” for the corresponding Monday and Tuesday. For example the market information request handler 405 may utilize a network connection to obtain the market information from the exchange and/or gateway and/or from a recorded market data buffer, cache, and/or other storage.

The order request miner 410 analyzes and processes the market information for Monday and Tuesday to extract and/or identify the information relevant to the users request for a figure chart 500 of volumes of buy orders 515 and sell orders 520 for the tradeable object (e.g., range of prices, buy order volume, sell order volume, starting price, ending price, buy value area, sell value area, etc.). For example, the order miner 410 determines the range of prices associated with all “COYG” trade orders (e.g., the “COYG” market) occurring on Monday 505, and determines the range of prices associated with all “COYG” trade orders (e.g., the “COYG” market) occurring on Tuesday 510. As shown in the example of FIG. 5A, the range of prices is rendered by the example renderer 415 as a vertical line extending from the highest detected order price to the lowest detected order price. In the example of FIG. 5A, the highest priced order for Monday was placed at $98 and the lowest price order was placed at $88. Thus, the price range for Monday was $98-$88.

The order request miner 410 also determines a volume and type of each trade order in the specified time interval (e.g., Monday or Tuesday). For example, the order request miner 410 analyzes data associated with each of the trade orders in each specified time interval to determine if the trade order is designated as a buy order or a sell order. The order request miner 410 also determines the volume of units associated with each trade order. The order request miner 410, in some examples, may store the trade orders by type after a determination is made. In other examples, the order request miner 410 may tag the trade orders by order type such that they are identifiable by the example renderer 415. In yet other examples, the volume and associated order type at each price is stored in a separate file by the example order request miner 410.

The example renderer 415 renders graphical representations for each buy volume 515 and each sell volume 520 for the Monday price range in the first figure chart 505. The renderer 415 generates graphical representations of buy order volume and sell order volume for each price in the Tuesday price range in the second figure chart 510.

In the illustrated example FIG. 5A, the graphical representations of buy order volume and sell order volume are rendered by the renderer 415 with a shared base (e.g., the vertical price range line) and extend in directions indicative of the order type. That is, a direction (e.g., right, left, up, down, etc.) indicates a type associated with the represented order, and a dimension (e.g., length, width, etc.) indicates a magnitude (e.g., a value) of that order. In the illustrated example of FIG. 5A, an amount of extension of a bar in the right hand direction is indicative of an amount of the buy orders at that price. Accordingly, the amount of extension of a bar in the left hand direction is indicative of the amount of sell orders at that price.

FIG. 5B illustrates another embodiment of the example graphical display 500 including the figure charts 505, 510 visually representing different volumes of trading activity for a tradeable object generated according to example methods and systems disclosed herein. In the example FIG. 5B, further details are generated and represented in association with figure charts 505, 510 generated in FIG. 5A.

More specifically, in the illustrated example of FIG. 5B, the user has requested that buy value area 525, sell value area 527, buy order opening price 530, buy order closing price 535, sell order opening price 532, and sell order closing price 537 be depicted in the Monday figure chart 505 and the Tuesday figure chart 510.

In the illustrated example of FIG. 5B, the market information request handler 405 identifies that the user of the trading device desires to amend the figure chart for Monday 505 with indications of the buy and sell value areas of tradeable object “COYG”. The order request miner 410 determines from the obtained market information (e.g., the volume of buy orders and the volume of sell orders) from the Monday time interval that 70% of the buy orders (e.g., the buy value area 525) are associated with a range of three prices and that 70% of the sell orders (e.g., the sell value area 527) are associated with a range of four prices. The order request miner 410 transmits to the renderer 415 the determined value areas (e.g., buy value area 525 and sell value area 527). The example renderer 415 generates representations of the buy value area 525 and the sell value area 527 in the charting area 500 with respect to the identified prices in the corresponding value area.

In the illustrated example of FIG. 5B, the example renderer 415 obtains the buy order opening price 530 and the buy order closing price 535 from the order request miner 410 and generates graphical representations 530, 535 superimposed on the corresponding graphical representations for buy volume at the corresponding opening price 530 and closing price 535. Similarly, the example renderer 415 obtains the sell order opening price 532 and the sell order closing price 537 from the order request miner 410 and generates graphical representations 532, 537 superimposed on the corresponding graphical representations for buy volume at the corresponding opening sell order price 532 and closing sell order price 537. A direction and dimension of each displayed bar are determined and used to generate the visual representation based on a type (e.g., buy, sell, etc.) and magnitude (e.g., price, quantity, etc.) of the respective order.

The buy value area 525, sell value area 527, buy order opening price 530, buy order closing price 535, sell order opening price 532, and sell order closing price 537 for the Tuesday figure chart 510 are constructed as described above with respect to the Monday figure chart 505.

FIG. 5C shows another embodiment of the figure charting area 500 including figure charts 505 and 510 configured to only display representations of the buy value area 525 and the sell value area 527 (e.g., value area figure charts).

In the illustrated example of FIG. 5C, the renderer 415 removes the graphical representations for the volume of buy orders and the volume of sell orders (e.g., buy order volume 515, sell order volume 520, of FIGS. 5A, 5B) from the figure chart 505. Across the range of prices determined as the value areas by the order request miner 410, the renderer 415 generates graphical representations of the buy value area 525 and the sell value area 527. In some examples, the renderer 415 may generate only one of the value areas.

While not depicted, in some examples the buy order opening price 530, buy order closing price 535, sell order opening price 532, and sell order closing price 537 of FIG. 5B may be rendered with the figure charts 505, 510 of example FIG. 5C at the request of the user.

In operation, the relative positions of the buy value area and the sell value area may be analyzed to determine trends in the market. For example, when the sell value area is depicted and positioned lower relative to the buy value area, it may be inferred that the market participants (e.g., limit order participants) are driving the trading activity. In other words, the relative position of the sell value area to the buy value area indicates that the market participants have generally bought the tradeable objects at a low price and have generally sold the tradeable objects at a higher price. Similarly, when the sell value area is depicted and positioned higher relative to the buy value area, it may be inferred that the market participants (e.g., limit order participants) are not driving the trading activity. In this instance, the relative position of the sell value area to the buy value area indicates that the market participants have generally bought the tradeable objects at a high price and have generally sold the tradeable objects at a lower price.

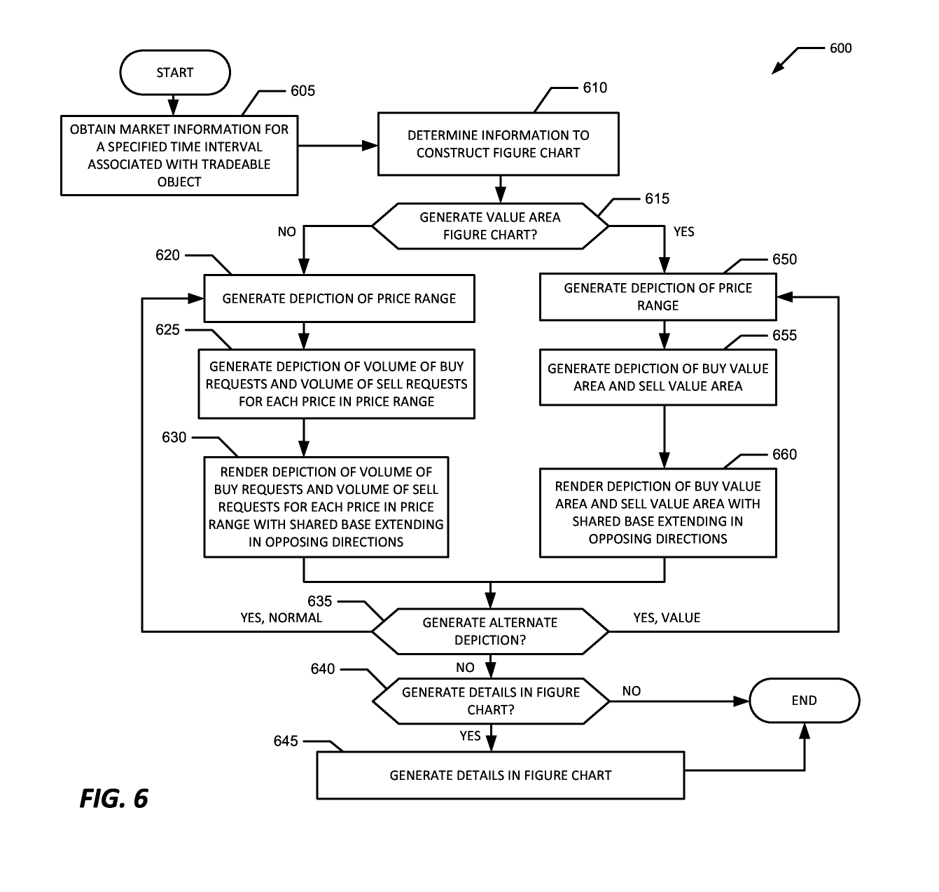

FIG. 6 is a flow diagram of example instructions 600 for generating figure charts. The example instructions 600 begin when a request to generate a figure chart for a tradeable object is detected by the market information request handler 405. When the request is detected, the market information request handler 405 determines which tradeable object is to be depicted in a figure chart. The market information request handler 405 also determines, from the request, the time interval from which to obtain market information. When the market information request handler 405 has determined the tradeable object and the time interval, the market information request handler 405 obtains the market information for the time interval from a gateway and/or electronic exchange (block 605).

When the market information is obtained by the market information request handler 405, the example order request miner 410 determines the information necessary to construct the figure chart (block 610). Such information may include, for example, a range of prices associated with obtained trade orders, total volume of units of the tradeable object in the trade orders, time of the trade order, the price at which the trade order was placed, and the type of the trade order (e.g., buy or sell). The order request miner 410 separates the volume of orders at each price in the price range into buy order volume and sell order volume. The order request miner 410 also determines from the obtained trade orders the value areas for buy orders and sell orders to accommodate the generation of a value area figure chart (block 610). Additionally, at block 610 the order request miner 410 determines the buy order opening price, buy order closing price, sell order opening price, and sell order closing price.

The example renderer 415 determines if the request made by the user was a request to generate a value area figure chart (block 615). If the request was not to generate a value area figure chart, control proceeds to block 620.

The example renderer 415 generates a depiction of the price range (e.g., a base or reference line or other common point representative of the range of prices determined by the order request miner 410) in a charting area (block 620). The example renderer 415 obtains the buy order volume and the sell order volume from the order request miner 410 and generates graphical representations (e.g., depictions) of buy order volume and sell order volume for each price in the price range (block 625). When the graphical representations of buy order volume and sell order volume for each price in the price range are generated, the graphical representations are rendered for each price by the example renderer 415 affixed to the price range depiction generated in block 620 by the renderer 415 (block 630). The graphical representations are rendered by the renderer 415 such that each representation expands in a direction associated with a buy order or a sell order and further rendered by the renderer 415 such that the amount the graphical representations extend with respect to the magnitude of activity at that price for that order type.

After the figure chart is rendered in block 630, the renderer 415 determines if an alternate figure chart is to be generated (e.g., a figure chart to value area figure chart conversion and vice versa) (block 635). If an alternate figure chart is to be generated, such a value area figure chart, control returns to block 650. Alternatively, if an alternate figure chart is to be generated such as a normal (e.g., non-value area) figure chart, control returns to block 620.

If no alternate figure chart is indicated to be generated, the example renderer 415 determines if additional details should be rendered in the chart area (block 640). For example, the renderer 415 may determine if buy order opening price, buy order closing price, sell order opening price, and sell order closing price should be generated in the chart area for the figure chart. If details are to be generated in the chart area for the figure chart, the renderer 415 generates the desired details (block 645). Upon generating the details at block 645, control suspends the program until such time that the market information request handler 405 detects another request to generate a figure chart for a tradeable object.

Returning to block 615, if a value area figure chart is requested, control proceeds to block 650. The example renderer 415 generates a depiction of the price range in the charting area similar to block 620 (block 650). In some examples, if the value area figure chart is generated as an alternate figure chart, the depiction of the price range generated at block 620 may be reused as the depiction of the price range.

The example renderer 415 obtains the buy value area and the sell value area determined by the order request miner 410 and generates graphical representations (e.g., depictions) of the buy value area and the sell value area with respect to the prices comprising the value area (block 655). When the graphical representations of buy value area and sell value area are generated, the graphical representations are rendered for the price range comprising the value area by the example render affixed to the price range depiction generated in block 650 by the renderer 415 (block 660). The graphical representations are rendered by the renderer 415 such that each representation expands in a direction associated with a buy value area or a sell value area.

After the value area figure chart is rendered in block 660, the renderer 415 determines if an alternate figure chart is to be generated (e.g., a figure chart to value area figure chart conversion and vice versa) (block 635). If an alternate figure chart is to be generated, such a value area figure chart, control returns to block 650. Alternatively, if an alternate figure chart is to be generated such as a normal (e.g., non-value area) figure chart, control returns to block 620. In some examples, when a normal and a value area figure chart have been rendered, control removes the option for alternate figure chart depiction and proceeds to block 640.

The example renderer 415 determines if additional details should be rendered in the chart area (block 640). For example, the renderer 415 may determine if buy order opening price, buy order closing price, sell order opening price, and sell order closing price should be generated in the chart area for the value area figure chart. If details are to be generated in the chart area for the value area figure chart, the renderer 415 generates the desired details (block 645). Upon generating the details at block 645, control suspends the program until such time that the market information request handler 405 detects another request to generate a figure chart for a tradeable object.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method comprising:
determining, using a processor, market information for a tradeable object, the market information comprising buy orders and sell orders with respect to the tradeable object;
determining, from the market information using the processor, a price range associated with the market information;
generating a base representation for the price range associated with the market information;
determining, from the market information using the processor, a volume of trade orders at each price in the price range;
separating the volume of trade orders at each price in the price range into a buy order volume and a sell order volume based on the market information;
generating first volume representations for the buy order volume for each price in the price range;
generating second volume representations for the sell order volume for each price in the price range; and
rendering, using the processor, the first volume representations and the second volume representations for each price in the price range with respect to the base representation, the first volume representations extending from the base representation in a first direction associated with the buy orders and the second volume representations extending from the base representation in a second direction associated with the sell orders.

2. The method of claim 1, further comprising:
determining a buy value range of the buy order volume, the buy value range comprising a threshold amount of buy orders;
determining a sell value range of the sell order volume, the sell value range comprising a threshold amount of sell orders;
generating, using the processor, a first value area representation of the buy value range and a second value area representation of the second range; and
rendering the first value area representation and the second value area representation with respect to the base representation, the first value area representation extending in the first direction associated with the buy orders and the second value area representation extending in the second direction associated with the sell orders.

3. The method of claim 2, wherein the first value area representation is superimposed on the first volume representations and the second value area representation is superimposed on the second volume representations.

4. The method of claim 2, wherein the first and the second value area representations are rendered separately from the first and the second volume representations.

5. The method of claim 2, further comprising:
generating a first icon on a respective one of the first and the second volume representations, the first icon representing an initial price with respect to the market information; and
generating a second icon on a respective one of the first and the second volume representations, the second icon representing a final price with respect to the market information.

6. The method of claim 1, wherein the first and the second volume representations are at least one of bars and lines with a length representative of a volume of orders at a price and a direction representative of order type.

7. A system comprising:
a processor configured to:
determine market information for a tradeable object, the market information comprising buy orders and sell orders with respect to the tradeable object;
determine, from the market information, a price range associated with the market information;
generate a base representation for the price range associated with the market information;
determine, from the market information, a volume of trade orders at each price in the price range;
separate the volume of trade orders at each price in the price range into a buy order volume and a sell order volume based on the market information;
generate first volume representations for the buy order volume for each price in the price range;
generate second volume representations for the sell order volume for each price in the price range; and
render the first volume representations and the second volume representations for each price in the price range with respect to the base representation, the first volume representations extending from the base representation in a first direction associated with the buy orders and the second volume representations extending from the base representation in a second direction associated with the sell orders.

8. The system of claim 7, wherein the processor is further configured to:
determine a buy value range of the buy order volume, the buy value range comprising a threshold amount of buy orders;
determine a sell value range of the sell order volume, the sell value range comprising a threshold amount of sell orders;
generate a first value area representation of the buy value range and a second value area representation of the second range; and
render the first value area representation and the second value area representation with respect to the base representation, the first value area representation extending in the first direction associated with the buy orders and the second value area representation extending in the second direction associated with the sell orders.

9. The system of claim 8, wherein the first value area representation is superimposed on the first volume representations and the second value area representation is superimposed on the second volume representations.

10. The system of claim 8, wherein the first and the second value area representations are rendered separately from the first and the second volume representations.

11. The system of claim 8, wherein the processor is further configured to:
generate a first icon on a respective one of the first and the second volume representations, the first icon representing an initial price with respect to the market information; and
generate a second icon on a respective one of the first and the second volume representations, the second icon representing a final price with respect to the market information.

12. The system of claim 7, wherein the first and the second volume representations are at least one of bars and lines with a length representative of a volume of orders at a price and a direction representative of order type.

13. A tangible computer readable storage medium comprising instructions that, when executed, cause a processor to at least:
determine market information for a tradeable object, the market information comprising buy orders and sell orders with respect to the tradeable object;
determine, from the market information, a price range associated with the market information;
generate a base representation for the price range associated with the market information;
determine, from the market information, a volume of trade orders at each price in the price range;
separate the volume of trade orders at each price in the price range into a buy order volume and a sell order volume based on the market information;
generate first volume representations for the buy order volume for each price in the price range;
generate second volume representations for the sell order volume for each price in the price range; and
render the first volume representations and the second volume representations for each price in the price range with respect to the base representation, the first volume representations extending from the base representation in a first direction associated with the buy orders and the second volume representations extending from the base representation in a second direction associated with the sell orders.

14. The computer readable storage medium of claim 13, wherein the instructions further cause the processor to at least:
determine a buy value range of the buy order volume, the buy value range comprising a threshold amount of buy orders;
determine a sell value range of the sell order volume, the sell value range comprising a threshold amount of sell orders;
generate a first value area representation of the buy value range and a second value area representation of the second range; and
render the first value area representation and the second value area representation with respect to the base representation, the first value area representation extending in the first direction associated with the buy orders and the second value area representation extending in the second direction associated with the sell orders.

15. The computer readable storage medium of claim 14, wherein the first value area representation is superimposed on the first volume representations and the second value area representation is superimposed on the second volume representations.

16. The computer readable storage medium of claim 14, wherein the first and the second value area representations are rendered separately from the first and the second volume representations.

17. The computer readable storage medium of claim 14, wherein the instructions further cause the processor to at least:
generate a first icon on a respective one of the first and the second volume representations, the first icon representing an initial price with respect to the market information; and
generate a second icon on a respective one of the first and the second volume representations, the second icon representing a final price with respect to the market information.

18. The computer readable storage medium of claim 13, wherein the first and the second volume representations are at least one of bars and lines with a length representative of a volume of orders at a price and a direction representative of order type.

19. The computer readable storage medium of claim 13, wherein the base representation comprises a line from which the first and second volume representations extend.

20. The computer readable storage medium of claim 19, wherein the base representation comprises a vertical line from which the first and second volume representations extend horizontally.
